(19) United States
(12) Patent Application Publication
(10) Pub. No.: US 2004/0083234 A1
(43) Pub. Date: Apr. 29, 2004

(54) System, program and method for producing computer application

(76) Inventor: Takashi Higuchi, Kobe-shi (JP)

Correspondence Address: CHRISTIE, PARKER & HALE, LLP, P.O. BOX 7068, PASADENA, CA, 91109-7068, US

(21) Appl. No.: 10/400,121

(22) Filed: Mar. 25, 2003

(30) Foreign Application Priority Data
Mar. 25, 2002 (JP) 2002-083713

(51) Int. Cl. G06F 17/00

(52) U.S. Cl. 707/104.1

(57) ABSTRACT

The present invention relates to application production for realizing new logic on the basis of applications saved in a plurality of electronic control units (ECUs) mounted in a vehicle. The plurality of existing applications is saved as a base of an application to be produced. An identifier is appended to file names of a plurality of data items contained in the applications. Double reading of the same file shared by the applications is avoided. When a produced application is transferred to a mass-produced ECU, identifiers are left intact. When the produced application is transferred while being divided into a plurality of applications to be installed in a plurality of ECUs, identifiers appended to respective file names are deleted.

### BACKGROUND OF THE INVENTION

1. Field of the Invention

The present invention relates to a system, program, and method for producing a computer application. More particularly, the present invention is concerned with a system, program, and method for producing a computer application according to which, when a microcomputer application is produced based on applications saved in a plurality of electronic control units (ECUs), files contained in the applications can be identified.

2. Description of the Related Art

In the past, the control of various types of equipment included in a vehicle such as an automobile or an electric railcar, an airplane, a manufacturing machine, or the like has been achieved using a computer and electronic devices. In this situation, when equipment that is an object of electronic control is, for example, a vehicle, an engine mounted in the vehicle is controlled by an electronic control unit (ECU). However, the ECU must be changed constantly in order to improve the performance thereof in compliance with an improvement in the performance of a computer (hereinafter, a microcomputer) and to meet the emission control standards.

Under the present circumstances, production of an application that realizes new logic precedes an advance in the performance of an existing ECU. The logic of an application produced precedently (hereinafter, preceding logic) is often targeted at the new generation of microcomputers whose performance is expected to improve. Moreover, a new-generation microcomputer whose performance has improved is selected based on a performance required for the preceding logic.

Whereas, at the current stage of producing an application programmed by the preceding logic, an ECU in which an upgraded new generation microcomputer is mounted is not realized. The preceding logic is usually produced based on applications designed for existing microcomputers. However, production of the preceding logic using an ECU in which an existing microcomputer is incorporated is confronted with problems including: (1) the throughput of a CPU included in the microcomputer is low; (2) the storage capacity of a memory included in the microcomputer is insufficient; (3) peripheral resources are insufficient; and (4) it takes too much time to produce and manufacture a new-generation ECU.

Because of these problems, if production of a new-generation microcomputer is delayed, production of new models of electronic control equipment that is controlled by an ECU having the new-generation microcomputer incorporated therein is hindered.

Incidentally, the performance of a CPU to be included in a microcomputer incorporated in an existing electronic control unit and peripheral equipment of the microcomputer are selected so that the specifications for the microcomputer will be optimal for an existing system. This is intended to minimize the cost of the electronic control unit. Furthermore, as the CPU and peripheral resources of the microcomputer are incorporated in one package, the features of the components cannot be modified unless the microcomputer is remodeled.

Moreover, in order to produce an application to be installed in a built-in microcomputer, a CPU must be designed to offer processing performance that is good enough to process the preceding logic. Moreover, resources that match a preceding system must be prepared as peripheral resources of the microcomputer. Furthermore, every time a new microcomputer is produced, an ECU that matches the microcomputer must be manufactured.

Accordingly, a microcomputer logic programming device that is repeatedly reusable has been produced (refer to PCT/JP02/12563). Herein, problems underlying production of preceding logic can be solved, and processing performance that is high enough to deal with the preceding logic can be provided as the capability of a CPU. As peripheral resources of a microcomputer, resources that match a preceding system can be prepared. Moreover, a built-in microcomputer in which preceding logic can be implemented can be produced quickly.

If a built-in microcomputer in which preceding logic to be realized with an application is implemented is produced using the above microcomputer logic programming device, an application actually saved in an ECU for controlling an engine that is mounted in an automobile may be utilized in order to produce the preceding logic. In this case, a production technique that old software serving as a base is modified in order to create new software is adopted. An application actually saved in a base ECU and serving as a base for production is installed in the application production device.

When an application is produced by installing an application that is actually saved in a base ECU and serves as a base for production, functions or variables contained in files constituting the application are logically modified through production. Nevertheless, filenames have a one-to-one relationship relative to the files constituting the old application and the files constituting a newly produced application alike. The produced files containing functions or variables are contained in the newly produced application as they are.

However, for example, when an attempt is made to produce a new application for a certain ECU for controlling an engine, an application actually run in a base ECU and an application residing in other base ECU may be integrated with each other. Otherwise, an application residing in other base ECU may be utilized in order to produce an upgrade version of the application.

In this case, applications residing in a plurality of base ECUs must be installed in the logic programming device. However, the applications include many files containing various functions or variables. The files include files that are compatible with all the applications and files that are exclusive to specific applications. The exclusive files containing functions or variables will not pose any problem when installed. However, when the compatible files containing functions or variables are included, the files containing functions or variables may have the same file name. In this case, after the files are installed, a duplicate file name is found. This becomes an obstacle to computation.

When a plurality of applications is installed in the logic programming device, an operator has to manually append identification information to files so that the files can be identified. Thus, the foregoing obstacle has been overcome in the past. However, this poses a problem in that the work is labor-intensive. Moreover, the manual work invites a typing error. Consequently, modifying software is a critical issue.

Moreover, after production of an application is completed, the application is loaded in a mass-produced ECU that is a product. At this time, the application saved in a memory in the logic programming device may have to be divided into a plurality of applications again. Consequently, the identification information that becomes unnecessary after completion of application production has to be deleted manually. The deleting work is also time-consuming.

An object of the present invention is to provide a system, program, and method for producing a microcomputer application according to which, when a new application is produced, identification information concerning an application can be automatically appended to files containing functions or variables and being included in a plurality of applications residing in base ECUs, and the applications can be installed. Moreover, when a produced application is transferred, the identification information is deleted if necessary.

### SUMMARY OF THE INVENTION

Accordingly, the present invention provides a microcomputer application production system that produces a new application by utilizing a plurality of existing applications. The microcomputer application production system consists mainly of: an identifier appending unit that appends identification information with which data items contained in a plurality of read microcomputer applications file can be identified; a saving unit that saves the applications as production software; an application producing unit that executes application production for the software; and an outputting unit that transfers the software, which has undergone the application production, as a new application.

The identifier appending unit appends an identifier, with which file can be identified irrespective of in which of the applications the file is contained, to file names of data items contained in the applications. An identifier with which file having the same file name and being contained in each of the applications can be identified is appended to the file name. No identifier is appended to shared file contained in the applications.

Furthermore, the saving means saves the same file, which is shared by the applications, so that double reading of the file can be avoided. The saving unit saves shared file so that double reading of the file can be avoided.

The outputting unit transfers the stored software as one application. Otherwise, when the stored software is transferred while being divided into a plurality of applications, identifiers appended to respective file names are deleted.

The data items contained in the applications are grouped into files containing functions, variables, or functions and/or variables. Furthermore, the applications are designed for microcomputers incorporated in electronic control units mounted in a vehicle.

Moreover, a facility implemented in the foregoing microcomputer application production system is provided as a microcomputer application production program to be run in a computer. Moreover, a method implemented in the microcomputer application production system is provided as a microcomputer application production method.

### BRIEF DESCRIPTION OF THE DRAWINGS

The above object and feature of the present invention will be more apparent from the following description of the preferred embodiments with reference to the accompanying drawing, wherein:

FIG. 1 is an explanatory diagram showing an overall configuration to which a microcomputer application production system in accordance with the present invention is adapted to a case where an application to be installed in an ECU is produced;

FIG. 2 is an explanatory diagram showing a configuration for producing a mass-produced ECU on the basis of a base ECU by utilizing a logic programming device;

FIG. 3 is an explanatory diagram schematically showing the internal configuration of the base ECU;

FIG. 4 is an explanatory diagram schematically showing the internal configuration of a microcomputer logic programming device;

FIG. 5A and FIG. 5B are explanatory diagrams showing concrete examples of applications installed in base ECUs; and

FIG. 6 is an explanatory diagram showing a way of identifying functions and variables contained in applications at the time of installing a plurality of software programs.

### DESCRIPTION OF THE PREFERRED EMBODIMENTS

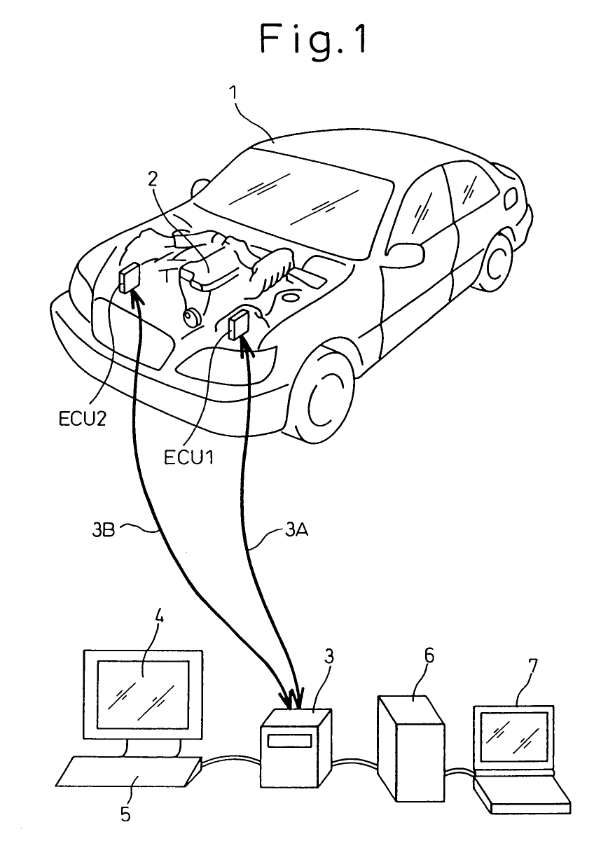

FIG. 1 shows a concrete example to which an application production system in accordance with an embodiment is adapted. In the concrete example, an application serving as a base of a new application to be produced is employed in an ECU mounted in a vehicle, for example, an automobile. The drawing illustrates a case where a plurality of ECUs is mounted in an automobile 1, that is, two ECUs of an ECU 1 and an ECU 2 are mounted in the automobile 1.

The ECU 1 and ECU 2 are placed in an engine compartment in the automobile 1 in which an engine 2 is mounted. Moreover, FIG. 1 shows a microcomputer logic programming device 3 that is employed in the present embodiment. According to the logic programming device 3 that produces an application to be installed in a microcomputer, as shown in the drawing, connectors of the ECU 1 and ECU 2 mounted in the automobile 1 are disjoined from connectors of respective pieces of control equipment. The connectors of the ECUs are then joined directly to connectors formed on the logic programming device 3 over connection cords 3A and 3B respectively.

Referring to FIG. 1, two ECUs mounted in the automobile 1 are connected to the logic programming device. Alternatively, the number of ECUs may be 1 or a plurality of ECUs equal to or larger than two may be connected to the logic programming device.

Reference numeral 4 denotes a display for use in monitoring the state of the microcomputer logic programming device 3. Reference numeral 5 denotes a keyboard serving as an input device for use in operating the microcomputer logic programming device 3, that is, for use in determining or modifying the settings of the microcomputer logic programming device 3.

The microcomputer logic programming device 3 employed in the present embodiment can be thus used while being directly connected to the automobile 1. Otherwise, the logic programming device 3 may be operated under the control of a personal computer 7 and can generate various driving situations of an automobile. When a driving situation generating device 6 for generating the driving situations of the automobile 1 is connected to the logic programming device 3, even if the automobile 1 does not exist, application production can be executed in order to produce an application that is to be installed in a microcomputer to be incorporated in, for example, an electronic fuel injection (EFI) ECU or an electronically controlled transmission (ECT) ECU.

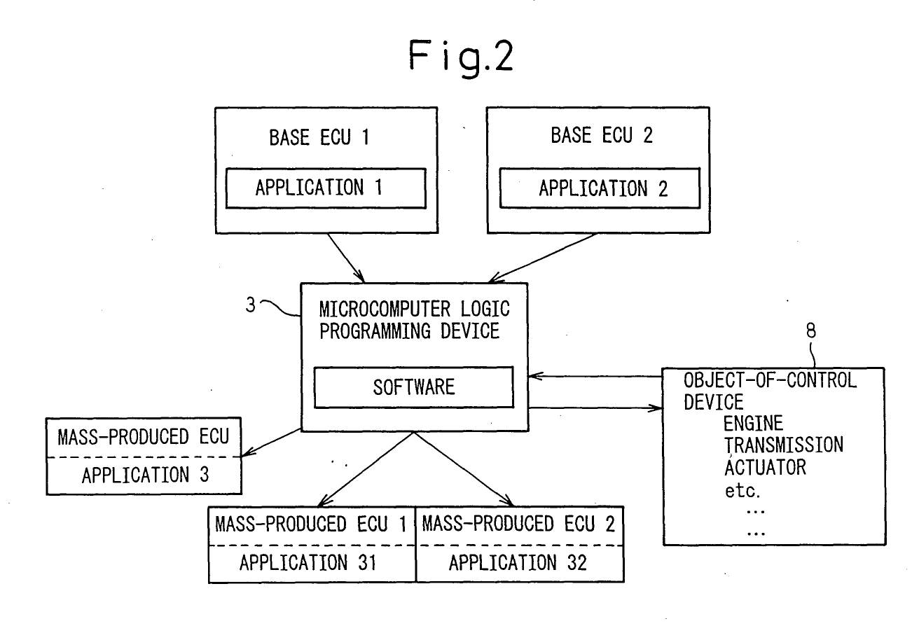

FIG. 2 schematically shows a case where applications residing in the base ECU 1 and base ECU 2 and serving as a base for production are installed in the logic programming device 3. An application 1 is saved in the base ECU 1, and an application 2 is saved in the base ECU 2. The applications 1 and 2 are installed as software, based on which a new application is produced, in the microcomputer logic programming device 3.

The logic programming device 3 utilizes the installed applications 1 and 2 so as to produce a new application according to control information concerning an object-of-control device 8 that is controlled by an ECU. The object-of-control device 8 may be object-of-control equipment actually mounted in the automobile 1 or manifested with driving situations generated by the driving situation generating device 6.

When the logic programming device 3 completes application production, the produced software is transferred to a mass-produced ECU that is a product. A new application 3 produced optimally for an object of control is stored in the mass-produced ECU.

Referring to FIG. 2, the applications 1 and 2 are installed as software in the microcomputer logic programming device 3. Alternatively, one application may be installed as software in the device 3 in order to produce a new sole application 3 for a mass-produced ECU. Otherwise, a plurality of applications may be installed and integrated into a new application 3 for a mass-produced ECU. Otherwise, the new application 3 may be divided into a plurality of new applications 31 and 32 and transferred to mass-produced ECUs 1 and 2 respectively.

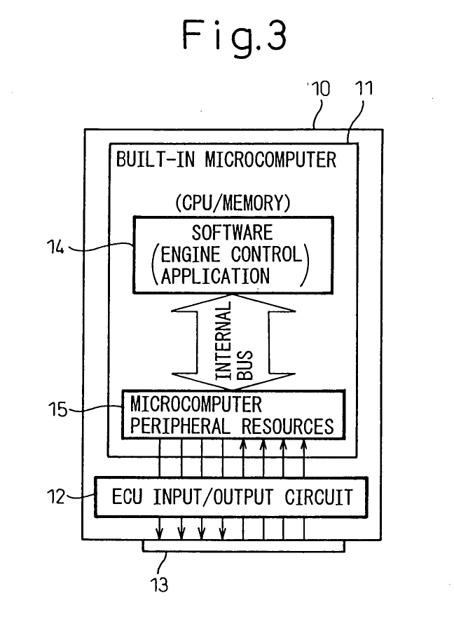

An overall procedure followed in the microcomputer application producing system in accordance with the present embodiment has been described so far. A base ECU that provides the system with an application serving as a base for production will be described below. FIG. 3 is an outline block diagram showing the base ECU.

FIG. 3 shows an ECU 10. The ECU 10 includes a built-in microcomputer 11 and an ECU input/output circuit 12 having a driver. Furthermore, the ECU 10 has an ECU connector 13 via which the ECU 10 is connected to object-of-control equipment mounted in the automobile 1 over a cable.

Moreover, software 14 to be read and run by a CPU is saved in a memory incorporated in the built-in microcomputer 11. FIG. 3 shows a case where an engine control application is saved as the software 14. Moreover, peripheral resources 15 relevant to the microcomputer are included. The software 14 can transfer data to or from the microcomputer peripheral resources 15 over an internal bus.

In the thus-configured ECU 10, the ECU input/output circuit 12 receives signals, which indicate the driven state of the automobile, from sensors and switches. The ECU input/output circuit 12 processes the input signals, and transfers the resultant signals to the built-in microcomputer 11. The received signals are converted into CPU values by an input resource included in the microcomputer peripheral resources 15. The memory and CPU included in an arithmetic unit are used to detect the state of a vehicle from the input signals. Consequently, an output request signal is produced depending on the state of the vehicle.

The output request signal is converted into an output signal by an output resource included in the microcomputer peripheral resources 15, and transferred from the built-in microcomputer 10. The driver included in the ECU input/output circuit 12 drives actuators mounted in the automobile according to the output signal. The actuators control object-of-control equipment.

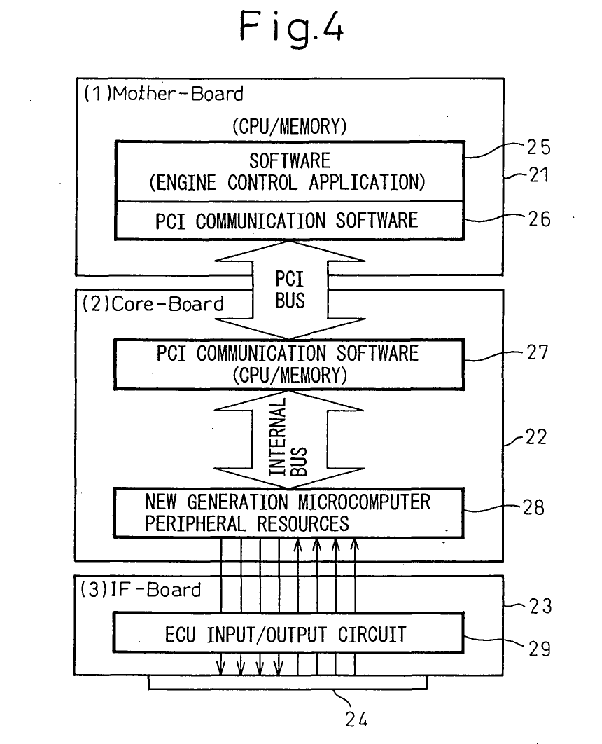

The configuration of the application production system that produces a new application on the basis of applications saved in ECUs each having the aforesaid configuration will be described with reference to FIG. 4. FIG. 4 is an outline block diagram showing the configuration of a device in which the application production system is installed.

FIG. 4 shows the configuration of the microcomputer logic programming device 3 that is included in the present embodiment and that produces a new application using applications saved in ECUs actually mounted in an automobile. The logic programming device 3 has three printed circuit boards of a motherboard 21, a core board 22, and an interface board 23.

The motherboard 21 and core board 22 correspond to the built-in microcomputer 11 included in the ECU 10 shown in FIG. 3. The interface board 23 corresponds to the ECU input/output circuit 13 included in the ECU 10. The motherboard 21 and core board 22 are connected to each other over a PCI (Peripheral Component Interconnect) bus that is a fast bus interface.

The motherboard 21 has software 25 and PCI communication software 26 saved in a memory. The software 25 is read by a CPU and used to produce a new application (FIG. 4 shows a case where an engine control application is saved). The PCI communication software 26 communicates with other software over the PCI bus. PCI communication over the PCI bus is communication of data, which is transferred to or from peripheral resources 28 relevant to a new-generation microcomputer over the PCI bus. The motherboard 21 must be provided with arithmetic performance and a storage capacity which are high enough and large enough to produce preceding logic for a new-generation ECU.

For example, as far as the existing engine control application is concerned, the performance of a microcomputer that runs the application should be such that a operating frequency of a CPU is about 66 MHz and a storage capacity of a memory is about 256 Kbytes. If a general-purpose microcomputer employed in locally procurable personal computer is adopted, the microcomputer would offer satisfactory performance. Moreover, the microcomputer can be reused many times over a long period of time.

Moreover, the PCI communication software 27 for enabling communications over the PCI bus and the new-generation microcomputer peripheral resources 28 are mounted on the core board 22 having a CPU and a memory. The peripheral resources 28 correspond to the microcomputer peripheral resources 15 relevant to the built-in microcomputer 11. The peripheral resources 28 include a field-programmable gate array (FPGA) and others so as to be adaptable to the new-generation microcomputer that is an object of application production. The PCI communication software 27 and new-generation microcomputer peripheral resources 28 transfer data to or from each other over the internal bus.

An ECU input/output circuit 29 corresponding to the ECU input/output circuit 12 included in the ECU 10 is mounted on the interface board 23. Furthermore, the interface board 23 has a connector 24. The ECU input/output circuit 29 is realized with a combination of standard circuit blocks that are independent of one another and can be flexibly modified. The connector 24 is joined directly to one or more of the ECU connectors 13 of the ECUs 1 and 2, or connected to one or more of the ECU connectors of the ECUS 1 and 2 via plugs of cables 3A and 3B.

In the microcomputer application production system having the aforesaid configuration, processing performance high enough to process new logic or a new-generation upgraded version of logic is ensured as the capability of a CPU, and resources compatible with a new-generation system are adopted as the microcomputer peripheral resources. Consequently, an application to be installed in a built-in microcomputer and used to realize new logic or new-generation logic can be readily and quickly produced. Moreover, as the application production system is usable repeatedly for production of an application to be installed in an ECU. This contributes to minimization of the costs of production.

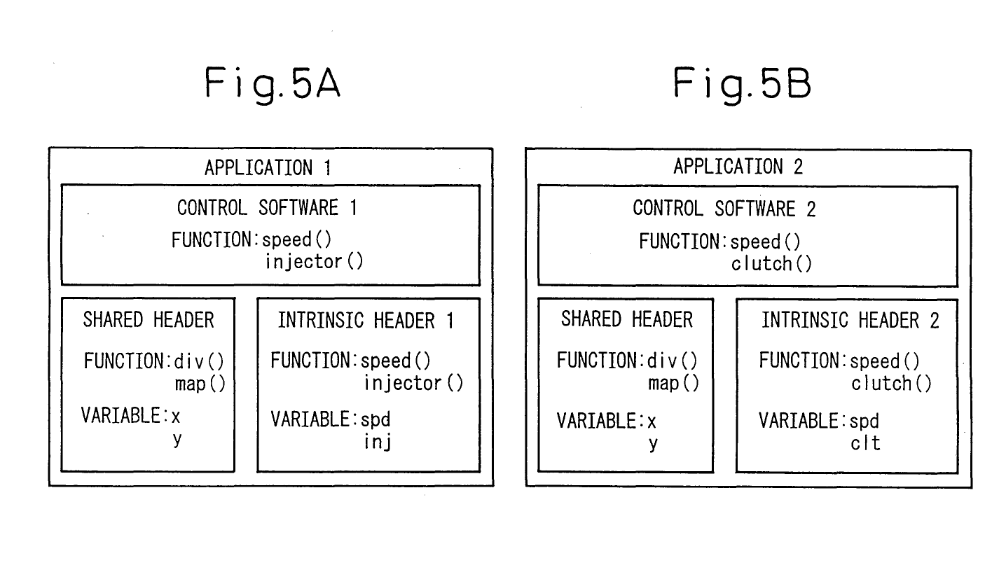

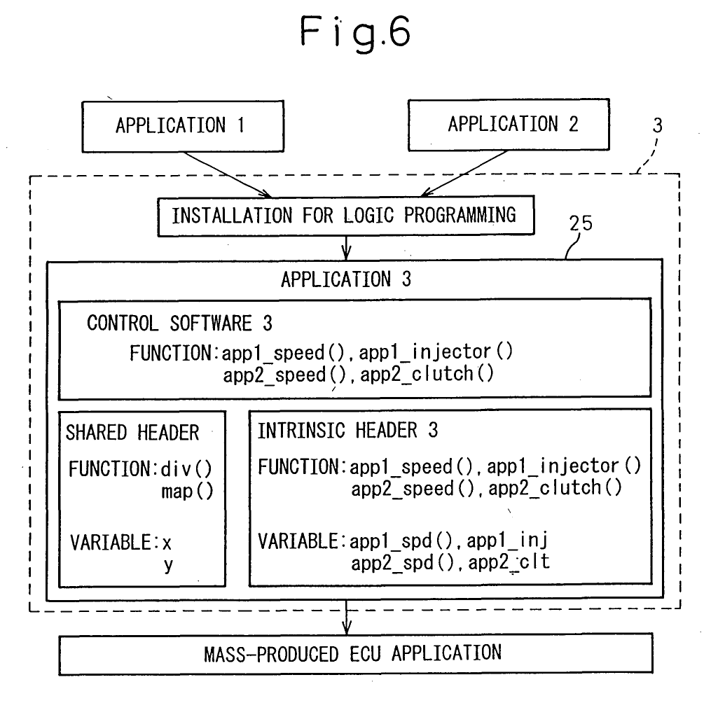

Referring to FIG. 5 and FIG. 6, a description will be made of a procedure of producing a new application, which realizes new logic or a new-generation upgraded version of logic, on the basis of the applications saved in, as shown in FIG. 1, the ECU 1 and ECU 2 mounted in the automobile 1 using the aforesaid application production system.

When a new application is produced using the application production system, for example, the ECU 1 and ECU 2 mounted in the automobile 1 are used as base ECUs, and the applications saved in the ECUs are installed in the memory included in the system. FIG. 5A and FIG. 5B show file structures concerning the applications that are saved in the ECUs and that are to be installed.

FIG. 5A shows the file structure of the application 1 saved as the software 14 in the base ECU 1. The application 1 consists broadly of the files of control software 1, a shared header, and an intrinsic header 1. In FIG. 5A, the application 1 is saved in, for example, the ECU for electronic fuel injection (EFI).

The control software 1 specifies “speed( )” and “injector( )” that are functions for executing an arithmetic operation required for electronic control. Furthermore, the application 1 includes header files that contain headers used to manage all other files included in the application. The header files include the shared header file and inherent header file. The shared header specifies functions of “div( )” and “map( )” and variables x and y. The intrinsic header 1 specifies functions of “speed( )” and “injector( )” and variables “spd” and “inj”. An application actually saved in an ECU includes a larger number of files. For simpler explanation, FIG. 5 only shows an example.

FIG. 5B shows the file structure of the application 2 saved as the software 14 in the base ECU 2. Herein, the ECU is adapted to, for example, an electronic controlled transmission (ECT). Similarly to the application 1, the application 2 consists broadly of the files of control software 2, a shared header, and an intrinsic header 2.

However, functions specified in the control software 2 and calculated depending on an object of control are “speed( )” and “clutch( )” different from those specified in the control software included in the application 1. Moreover, the shared header specifies file common to the applications. The contents of the shared header included in the application 2 is identical to those of the shared header included in the application 1. The contents of the intrinsic header 2 are inherent to the application 2, and the intrinsic header 2 specifies functions of “speed( )” and “clutch( )” and variables of “spd” and “clt”. FIG. 5B only shows an example of functions and variables that may be specified in the application 2. An actual application includes a larger number of files.

Next, a description will be made of a procedure of installing the applications 1 and 2 as software in the logic programming device 3 for the purpose of producing a new application 3, which realizes new logic or new-generation logic, on the basis of the applications 1 and 2 saved in the base ECUs and shown in FIG. 5A and FIG. 5B. FIG. 6 shows a state in which the applications are installed.

The application 1 saved in the actual ECU 1 as shown in FIG. 5A and the application 2 saved in the actual ECU 2 as shown in FIG. 5B are installed as software in the logic programming device 3. Similarly to the file structure of each of the applications, the files of control software 3, a shared header 3, and an intrinsic header 3 are stored in the logic programming device 3.

At this time, assume that the applications 1 and 2 shown in FIG. 5A and FIG. 5B are installed as they are. For example, when the functions specified in the control software are discussed, the function “speed( )” is specified in both the applications. The file name “speed( )” is therefore saved double. However, when the same file name is assigned to different data items, the applications in which the data items are specified cannot be distinguished from each other. This brings about a computational fault. The same applies to the data items constituting the inherent header.

All the data items specified in the shared header are used in common between the applications, and initiate the same actions. The functions and variables specified in the shared header are common to the applications. When the applications are installed, the shared header is read twice. Consequently, an unnecessary file is resident.

In the application production system in accordance with the present embodiment, when files included in applications to be installed are identical or duplicate to each other, one of the files is read. Otherwise, when two files of which the file names are same and both file names are read, identification information is appended to the file name so that in which of the applications the file is contained can be recognized.

To begin with, a case where one of the duplicate files is read will be described. When the applications 1 and 2 are installed, the data items specified in the shared headers contained in the applications are identical to each other. Therefore, for example, when the application 1 is installed first, reading the shared header file of the application 2 can be automatically disabled.

Otherwise, filenames to be installed are displayed in the form of a list which lists the filenames in association with applications, on the screen of the display 4 connected to the logic programming device 3. Furthermore, a check box is drawn at the start of each filename. A duplicate filename of a shared header is designated by clicking within a check box. Thus, reading a duplicate file may be avoided so that only one file can be read.

FIG. 6 shows a state in which the applications are saved as part of software 25 in the logic programming device 3 and the shared files of the shared headers included in the applications are not read double.

Next, with respect to two files of which the file names are the same and both file names are read, a description will be made regarding identifying in which applications those files are included. In this case, an identifier, with which an application in which file specified in control software or an intrinsic header is contained can be identified even after the application is installed, is automatically appended to the start of the file name.

For example, the function “speed( )” contained in the application 1 will be discussed. An identifier “appl” with which it is recognized that the function “speed( )” is contained in the application 1 is appended to the start of the file name. This results in a file name “app1_speed( )”. As for the function “speed( )” contained in the application 2, an identifier “app2” with which it is recognized that the function “speed( )” is contained in the application 2 is appended to the start of the file name. This results in a file name “app2_speed( )”.

FIG. 6 shows a state in which the files included in the applications 1 and 2 are integrated into an application 3 with an identifier appended to each file as mentioned above, and saved as software 25 in the logic programming device 3. Referring to FIG. 6, the identifier is appended to all data items contained in all the files other than the shared header file. The identifier may not be appended to all the data items. Alternatively, the identifier may be appended to data items having a duplicate file name.

The foregoing identifier is automatically appended to file during installation of an application. Alternatively, file names to be installed may be displayed in the form of a list, which lists the data items in association with applications, on the screen of the display 4 connected to the logic programming device 3. A check box may be drawn at the start of each file name. Whether an identifier is appended to a file name may be designated by clicking within the check box. Incidentally, the identifier may be identification information inherent to a model, such as, a folder name stored in the memory or a project name assigned to an application production project.

After the applications saved in the base ECU 1 and base ECU 2 are installed as the software 25 in the logic programming device 3, new logic or new-generation logic is produced based on the installed applications. Although a function or variable specified in each file included in each application may be modified during the production, each file name is used with an identifier kept appended thereto.

As shown in FIG. 2, after production is completed, files are integrated into an application to be installed in a mass-produced ECU that is a product. The ECU input/output circuit 29 transfers the application, and the application is installed in the mass-produced ECU. The transfer form has been described in conjunction with FIG. 2. Namely, one application may be installed and adopted as a sole new application 3 for a mass-produced ECU. Otherwise, a plurality of applications may be installed and integrated into one new application 3 for a mass-produced ECU. Otherwise, a plurality of applications may be installed and divided again in order to produce a plurality of new applications 31 and 32.

In relation to the above cases, how to handle an identifier appended to a file name will be described below. When one application is installed and adopted as a sole new application 3 for a mass-produced ECU, data items having undergone application production should be transferred to the mass-produced ECU as they are. Even if an identifier is appended to each file name for convenience sake in application production, the presence of the identifier will not pose any problem at the time of transfer.

When a plurality of applications is installed and integrated into one new application 3 for a mass-produced ECU, an identifier is appended to data items having a duplicate data name. Even after the integration, if an identical file name is found, a problem occurs. Therefore, the identifiers are not deleted but the file names having the identifiers appended thereto are used as they are. The identifiers may express the history of application production.

When the plurality of applications 1 and 2 is installed and divided again into a plurality of new applications 31 and 32, an identifier is appended to data items having a duplicate file name. When the data items constituting the software 25 are transferred as new applications for mass-produced ECUs, the data items can be classified into the associated applications according to the identifiers.

After the classified data items are distributed into the predetermined applications, even if the identifiers remain as the file names, no critical problem occurs. However, a file name may be too long because of an appended identifier. Moreover, an identifier may be unnecessary within a new application. In such a case, the identifier is automatically deleted from each file name, and the data items having original file names are distributed into the new applications 31 and 32 to be installed in the mass-produced ECUs 1 and 2 respectively.

As mentioned above, in the microcomputer application production system of the present embodiment, a new application is produced based on applications saved in one or more ECUs. At this time, double reading of an identical file is avoided, and data items having a duplicate file name are read with different identifiers appended to the file name. When software having undergone application production is used to transfer an application to a mass-produced ECU, if an appended identifier is unnecessary within the new application, the identifier is automatically deleted.

The microcomputer application production system of the present embodiment is installed in an logic programming device and works according to a program run by a computer.

A case where an application to be installed in a microcomputer incorporated in an electronic control unit mounted in a vehicle is produced has been described so far. The present invention is not limited to this case but can be adapted to production of applications to be installed in various devices controlled by a computer.

As mentioned above, according to the present invention, a computer application production system is installed in one logic programming device. Based on a plurality of applications relevant to a plurality of CPUs, new logic or an upgraded version of logic can be readily transferred as a newly produced application. When the plurality of applications serving as a base for production is installed in the logic programming device, reading of a duplicate file can be avoided. Moreover, a file having a duplicate file name can be identified and read. This obviates the necessity of manually modifying application software at the of installation.

What is claimed is:

1. A computer application production system comprising:
an identifier appending unit for appending identification information with which file contained in any of a plurality of read computer applications can be identified;
a saving unit that saves the applications as production software;
an application producing unit for executing application production for the software; and
an outputting unit for transferring the software, which has undergone the application production, as a new application.

2. A computer application production system according to claim 1, wherein said identifier appending unit appends an identifier, with which file can be identified irrespective of in which of the applications the file is contained, to file names of data items contained in the applications.

3. A computer application production system according to claim 2, wherein said identifier appending unit appends an identifier, with which file having the same file name and being contained in each of the applications can be identified, to the file name of each file.

4. A computer application production system according to claim 3, wherein said identifier appending unit appends no identifier to shared file contained in the applications.

5. A computer application production system according to claim 1, wherein said saving unit saves the same file, which is shared by the applications, so that double reading of the file can be avoided.

6. A computer application production system according to claim 4, wherein said saving unit saves the shared file so that double reading of the file can be avoided.

7. A computer application production system according to claim 1, wherein said outputting unit transfers the stored software as one application.

8. A computer application production system according to claims 2 or 5, wherein when said outputting unit transfers the stored software while dividing it into a plurality of applications, identifiers appended to respective file names are deleted.

9. A computer application production system according to claim 1, wherein data items contained in the applications are grouped into files containing functions, variables, or functions and/or variables.

10. A computer application production system according to claim 1, wherein the applications are designed for microcomputers incorporated in electronic control units mounted in a vehicle.

11. A computer application production program causing a computer to perform:
an appending step of appending identification information with which data contained in any of a plurality of read computer applications can be identified;
a saving step of saving the applications as production software;
a producing step of executing application production for the software; and
an outputting step of transferring the software, which has undergone the application production, as a new application.

12. A computer application production program according to claim 11, wherein at said appending step, an identifier with which file can be identified irrespective of in which of the applications the file is contained, to file names of data items contained in the applications.

13. A computer application production program according to claim 12, wherein at said appending step, an identifier with which file having the same file name and being contained in each of the applications can be identified is appended to the data item of each data.

14. A computer application production program according to claim 13, wherein at said appending step, no identifier is appended to shared file contained in the applications.

15. A computer application production program according to claim 11, wherein at said saving step, the same file shared by the applications is saved so that double reading of the file can be avoided.

16. A computer application production program according to claim 14, wherein at said saving step, the shared file is saved so that double reading of the file can be avoided.

17. A computer application production program according to claim 11, wherein at said outputting step, the stored software is transferred as one application.

18. A computer application production program according to claims 12 or 15, wherein at said outputting step, when the stored software is transferred while being divided into a plurality of applications, identifiers appended to respective file names are deleted.

19. A computer application production program according to claim 11, wherein data items contained in the applications are grouped into files containing functions, variables, or functions and/or variables.

20. A computer application production program according to claim 11, wherein the applications are designed for microcomputers incorporated in electronic control units mounted in a vehicle.

21. A computer application production method for causing a computer to perform:
an appending step of appending identification information with which file contained in any of a plurality of read computer applications can be identified;
a saving step of saving the applications as production software;
a producing step of executing application production for the software;
an outputting step of transferring the software, which has undergone the application production, as a new application.

22. A computer application production method according to claim 21, wherein at said appending step, an identifier with which file can be identified irrespective of in which of the applications the file is contained, is appended to file names of data items contained in the applications.

23. A computer application production method according to claim 22, wherein at said appending step, an identifier with which file having the same file name and being contained in each of the applications can be identified is appended to the file name of each file.

24. A computer application production method according to claim 23, wherein at said appending step, no identifier is appended to shared file contained in the applications.

25. A computer application production method according to claim 21, wherein at said saving step, the same file shared by the applications is saved so that double reading of the file can be avoided.

26. A computer application production method according to claim 24, wherein at said saving step,.the shared file is saved so that double reading of the file can be avoided.

27. A computer application production method according to claim 21, wherein at said outputting step, the stored software is transferred as one application.

28. A computer application production method according to claim 22 or 25 wherein, at said outputting step, when the stored software is transferred while being divided into a plurality of applications, identifiers appended to respective data items are deleted.

29. A computer application production method according to claim 21, wherein data items contained in the applications are grouped into files containing functions, variables, or functions and/or variables.

30. A computer application production method according to claim 21, wherein the applications are designed for microcomputers incorporated in electronic control units mounted in a vehicle.
